(19) United States
(12) Patent Application Publication
(10) Pub. No.: US 2010/0125839 A1
(43) Pub. Date: May 20, 2010

(54) Specifying, Determining and Overriding Software Dependencies

(76) Inventors: Michael J. Gebis, Westlake Village, CA (US); Praveen H. Venkataramaiah, Woodland Hills, CA (US); Sam R. Fatoohi, Los Angeles, CA (US); Jan Olderdissen, Simi Valley, CA (US)

Correspondence Address: SoCAL IP LAW GROUP LLP, 310 N. WESTLAKE BLVD. STE 120, WESTLAKE VILLAGE, CA, 91362, US

(21) Appl. No.: 12/275,059

(22) Filed: Nov. 20, 2008

(51) Int. Cl. G06F 9/44

(52) U.S. Cl. 717/170

(57) ABSTRACT

There is disclosed apparatus and processes for managing dependencies of program packages available to be run on a processor. The program packages have respective version numbers, and plural versions of at least one of the program packages are available to be run on the processor. Default dependency settings may be overridden by a user. During run-time, the override settings are referenced and utilized.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to specifying, determining and overriding software dependencies.

2. Description of the Related Art

Application software is a subclass of computer software that employs the capabilities of a computer to a task that the user wishes to perform. This may be contrasted with system software which is involved in integrating a computer's various capabilities, but typically does not directly benefit the user. Application software typically relies on services and capabilities provided by or though the system software. Typical examples of applications software are word processors, spreadsheets, and media players. Typical examples of system software are computer operating systems, such as, for example, Unix, Linux, Microsoft Windows, Apple Mac OS, Symbian, and others.

Application software typically takes the form of application programs and software components. An application program is an executable software component or tightly coupled set of executable software components (one or more), deployed together, that deliver some or all of a series of steps needed to create, update, manage, calculate or display information for a specific business purpose. In order to be counted as a software component, each component must not be a member of another application program. A software component is an executable set of computer instructions provided in a single deployment container (e.g., a file) in such a way that it cannot be broken apart further. Examples include a Dynamic Link Library, an ASP web page, and a command line executable (“EXE”) application. For convenience, the term program package is used in this patent as a generic term for both application programs as defined in this paragraph and software components as defined in this paragraph.

Program packages are typically issued or released in versions, with each version being assigned a distinct version number. Version numbers therefore identify a particular issue or release, and versions later in time typically have increasingly higher version numbers. Version numbers often include decimal fractions, and often sub-decimals. Major changes are generally marked by an increase in whole numbers, whereas for minor changes only the less significant numbers increase. For example, one format is major.minor.branch.build. Sometimes version numbers include letters, so it may be more appropriate to consider them to be codes, though number is the accepted nomenclature.

After a program package has been installed, typically after a new version is made available the installed program package will be updated to the new version. In general, software updates are unidirectional and therefore irreversible. Sometimes, reversibility is built into an upgrade, although this is not generally done. One typical reversibility limitation is the inability to reverse more than one upgrade version. Another typical limitation is the inability to reverse an upgrade after the program package has been used, or used extensively. Yet another typical limitation is the inability to reverse an upgrade when some other program package has also been upgraded or modified.

Users often install multiple versions of the same program package. Sometimes, different program packages depend on one another. Through dependencies, a program package can take advantage of other software components that are already available. The installation packages for most program packages include a list of dependencies. During installation of software packages under some operating systems, the program package's dependencies are stored in a central repository, such as the Registry of Microsoft Windows. Thus, during run time, when a program package needs a depended-upon software component, the program package refers to the dependency list to get the proper version of the depended-upon software component.

There are at least seven classes of dependencies, also known as coupling. Content coupling is when one program package modifies or relies on the internal workings of another program package. Common coupling is when two program packages share the same global data. External coupling occurs when two program packages share an externally imposed data format, communication protocol, or device interface. Control coupling is when one program package controls the logic of another program package by passing information on what to do. Stamp coupling is when program packages share a composite data structure and each program package uses only a part of the data structure, possibly a different part. Data coupling is when program packages share data through, for example, parameters. In message coupling, program packages are not dependent on each other; instead, they use a public interface to exchange parameter-less messages.

Typically, a program package will use the newest version of the program packages upon which it depends. Sometimes, software dependencies can lead to operation errors.

Dependencies can be quite complex. Because different pieces of software have different dependencies, it is possible to get into a vicious circle of dependency requirements, or an ever-expanding tree of requirements, as each new program package demands several more be installed. Dependency problems have been more troubling with some open source software where there is no central control.

Another dependency problem arises when a program package has many dependencies. For example, a program package might depend on many libraries, requiring lengthy downloads, large amounts of disk space, and not being very portable (all libraries must be ported for the application to be ported). It can also be difficult to track down all the dependencies, even with a central storage space such as the Windows Registry. A program package built on a given platform (such as Java) requires that platform to be installed, but other applications might not require it. This is a particular problem if an application uses a small part of a big library (which can be solved by refactoring), or a simple application relies on many libraries.

Even where a program package has only one dependency, it can be a long chain. For example, program package A depends on program package B, and program package B depends on program package C, and program package C depends on program package D.

Dependencies can conflict. For example, consider a situation where program package E depends on version 1.2 of program package F, and program package G depends on version 1.3 of program package F. If different versions of program package F cannot be simultaneously installed, then program package E and program package G cannot simultaneously be used, and the operating system or installer system may prevent an installation which creates a dependency conflict.

One common solution to dependency problems is to have a standardized numbering system, wherein software uses a specific number for each version (aka major version), and also a subnumber for each revision (aka minor version), e.g., 10.1 or 5.7. The major version only changes when programs that used that version will no longer be compatible. The minor version might change with even a simple revision that does not prevent other software from working with it. In cases like this, program packages can then simply request a component that has a particular major version, and any minor version (greater than or equal to a particular minor version). As such, program packages will continue to work, and dependencies will be resolved successfully, even if the minor version changes.

Another solution is to use a package manager, which is typically part of the operating system. A package manager is a collection of tools to automate the process of installing, upgrading, configuring, and removing software packages from a computer. Some package managers can perform smart upgrades, in which interdependent software components are upgraded at the same time, thereby resolving the major number incompatibility issue too. Package managers typically also manage dependencies to ensure a program package is installed with all the other program packages it requires.

When a user interacts with the package manager to bring about an upgrade, it is customary to present the user with the list of things to be done (usually the list of packages to be upgraded, and possibly giving the old and new version numbers), and allow the user to either accept the upgrade in bulk, or select individual program packages for upgrades. Many package managers can be configured to never upgrade certain program packages, or to upgrade them only when critical vulnerabilities or instabilities are found in the previous version, as defined by the packager of the software. This process is sometimes called version pinning.

### DESCRIPTION OF THE DRAWINGS

FIG. 1 is a block diagram of a computer system having a manager program for managing dependencies.

FIG. 2 is a dependency list format.

FIG. 3 is a sample dependency list.

FIG. 4 is a screen shot of a manager program's main display with sample data.

FIG. 5 is a flow chart of a process for running a program package.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

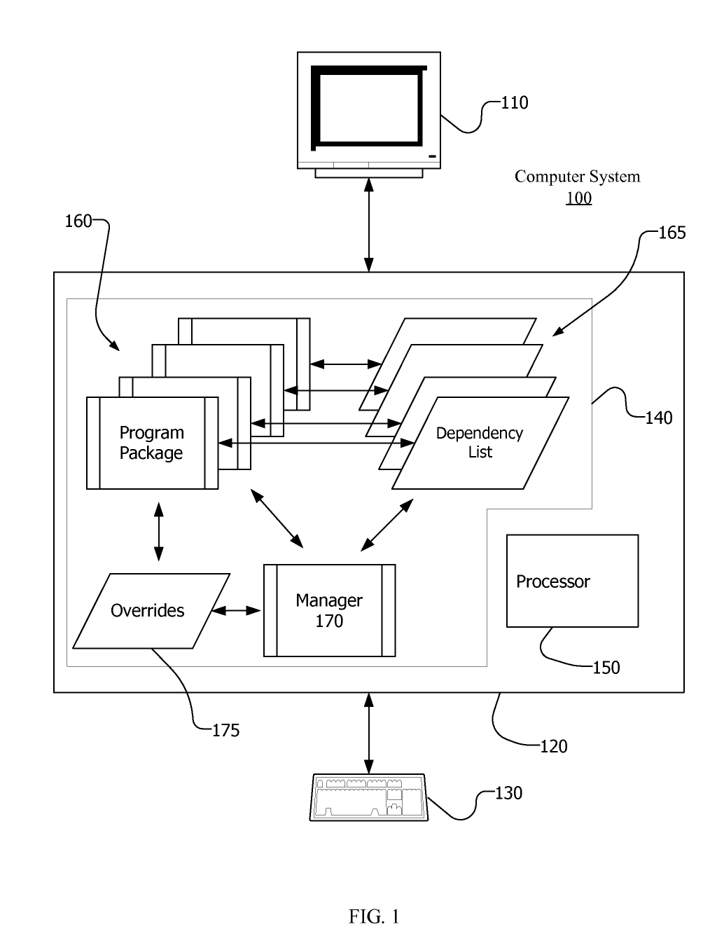

Referring now to FIG. 1 there is shown a block diagram of a computer system 100. The computer system 100 includes a storage medium 140, a display 110, a user input device 130 such as a keyboard, and a processor 150. Other components may be included with the computer system 100, including, for example, memory such as random access memory (RAM), a network interface in the form of a chip, chipset or add-on board, that provides support for network communications, and others. Although only one of a storage medium 140, a display 110, a user input device 130, and a processor 150 are shown, the computer system may have two or more of any of these components.

The storage medium may have stored therein a manager program 170 for managing dependencies and one or more program packages 160, all installed in the computer system 100 and available to run on the processor 150. Additional program packages may be available to be run on the processor 150 but not installed on the storage medium, and may be for example available via a network (not shown). Also, there may be network program packages whose components are distributed partially on the storage medium and partially outside of the computer system 100 but nonetheless available to the processor 150. These variations of how program packages are installed, stored and made available to be run on the processor will be referred to herein for convenience generically as installed in the computer system 100. Thus, even if a given program package is not physically stored in the storage medium 140, it is considered installed in the computer system 100 if it is available to be run on the processor.

The manager program 170 has instructions which when executed by the processor 150 will cause the processor 150 to manage dependencies of one or more of the program packages installed in the computer system 100. The manager program 170 may use an overrides file 175 which stores information about overrides to default dependency settings.

The program packages 160 may have respective version numbers. Amongst the program packages, some may be a single version, and there may be two or more versions of other program packages. Separate versions of the same program package may be physically distinct or may have some shared components. Some program packages may have no dependencies, and other program packages may depend on one or more other program packages. Some program packages may be depended upon by one or more other program packages, and some program packages may not be depended upon by any of the other program packages. During the lifetime of the computer system 100, program packages and various versions of program packages may be installed and uninstalled.

During installation or upgrading of a given program package, a new or updated dependency list 165 may also be installed (i.e., installed on the storage medium 140 or made available to the processor 150). The dependency list 165 may be assigned a name corresponding to the program package, or placed in a location which shows the association between the dependency list and its program package. Alternatively there may be an index of program packages and their respective dependency lists which may be stored in the storage medium 140 or otherwise made available to the processor 150. There may be a single dependency list for all program packages. Each of the dependency lists 165 may be stored as separate files on storage medium 140. Each of the dependency lists 165 may be stored in a single file on storage medium 140.

The program packages 160 may also obtain dependency information from the overrides file 175, either directly or indirectly. In the indirect route, the program packages 160 may depend on the manager program 170 to provide the override information from the overrides file 175, i.e., for override information services.

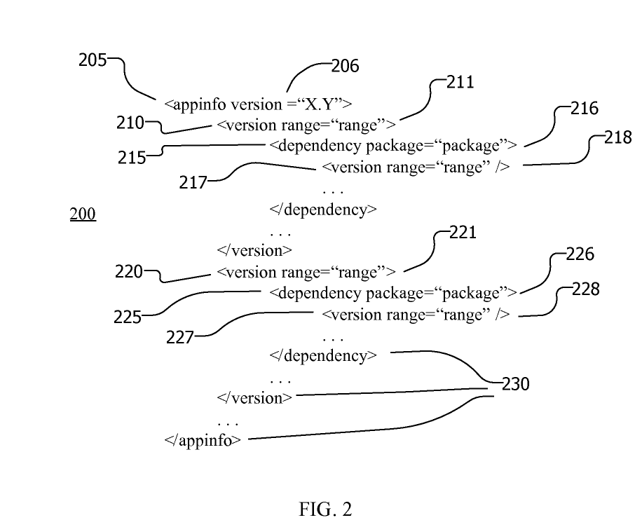

Referring now to FIG. 2 there is shown a format of a dependency list 200 as one possible way to provide a format. The format follows accepted HTML or XML-type norms for elements and structure. The dependency list 200 may be a hierarchical arrangement of dependencies for one or more installed versions of a given program package, referred to in this description as the “primary” program package. Thus, for the respective primary program package, the dependency list 200 includes a list of program packages upon which the primary program package is dependent. These depended-upon program packages are referred to in this description as “secondary” program packages. An “appinfo” element 205 identifies the structure as a dependency list, and may also have a “version” field 206 which identifies a version of a specification which defines the format and structure of the dependency list 200.

Within the dependency list 200 there may be one or more “version” elements 210, 220 and corresponding “range” fields 211, 221. At this level of the hierarchy, i.e., immediately below the appinfo element 205, the version element may be used to identify one or more versions and/or ranges of versions of the primary program package. In situations where there is more than one installed version of the primary program package, and at least some of the installed versions have differing dependencies, separate version elements 210, 220 may be included for each differing dependency configuration. The identification of versions may be by version number, using a code, or otherwise.

Below the version element 210, 220 in the hierarchy, there may be one or more “dependency” elements 215, 225 and corresponding “package” fields 216, 226. The dependency elements 215, 225 identify in the package field 216, 226 one or more secondary program packages upon which the primary program package depends. The identification may be by name, code or otherwise. For various reasons, some secondary program packages may be omitted from the dependency list 200.

Below the dependency elements 215, 225 in the hierarchy, there may be a sub-list of one or more version elements 217, 227 and corresponding range fields 218, 228. These version elements 217, 227 and range fields 218, 228 may have the same respective formats as the version elements 210, 220 and range fields 211, 221. However, the version elements 217, 227 are used to identify the respective versions of the secondary program packages identified in the dependency elements 215, 225. Thus, the version element may appear multiple times in both the appinfo and dependency elements. The dependency element can appear multiple times in each appinfo/version element.

In keeping with common practice for these kinds of elements, corresponding closing elements 230 may be included in the dependency list for each open element such as the appinfo element 205, version element 220, and dependency element 225.

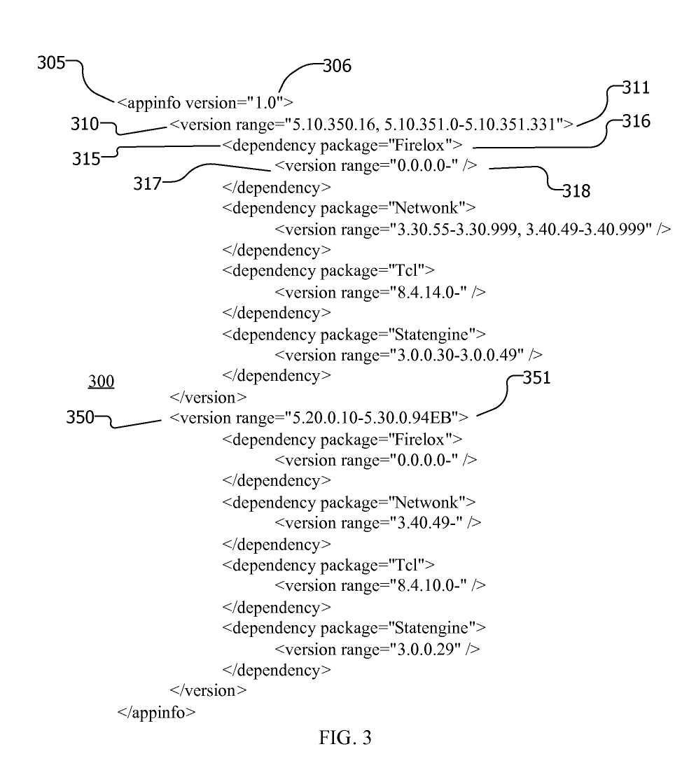

Referring now to FIG. 3 there is shown an example of a dependency list 300 in accordance with the format of FIG. 2. The dependency list 300 is for a primary program package which conforms to “appinfo” version 1.0 shown as element 305 with version field 306. The dependency list 300 of the primary program package has two version elements 310, 350 with respective range fields 311, 351. The first range field 311 value is version 5.10.350.16 and versions 5.10.351.0 through 5.10.351.331. The second range field 351 value is versions 5.20.0.10 through 5.30.0.94EB.

The primary program package is dependent upon four secondary program packages named Firelox, Netwonk, Tcl and Statengine. (All program package names used in the examples of this patent are either arbitrary or coined and not meant to refer to any known program packages.) Both the first version element 310 and the second version element 350 show the same four secondary program packages, though this is just an example. Different versions of a given primary program package may have entirely different dependencies.

The primary program package versions of the first version element 310 are compatible with version 0.0.0.0 and higher of Firelox. The primary program package versions of the first version element 310 are compatible with versions 3.30.55 through 3.30.999 and 3.40.49-3.40.999 of Netwonk. The primary program package versions of the first version element 310 are compatible with version 8.4.14.0 and higher of Tcl. The primary program package versions of the first version element 310 are compatible with versions 3.0.0.30 through 3.0.0.49 of Statengine.

The primary program package versions of the second version element 350 are compatible with version 0.0.0.0 and higher of Firelox. The primary program package versions of the second version element 350 are compatible with versions 3.40.49 and higher of Netwonk. The primary program package versions of the second version element 350 are compatible with version 8.4.10.0 and higher of Tcl. The primary program package versions of the second version element 350 are compatible with only version 3.0.0.29 of Statengine.

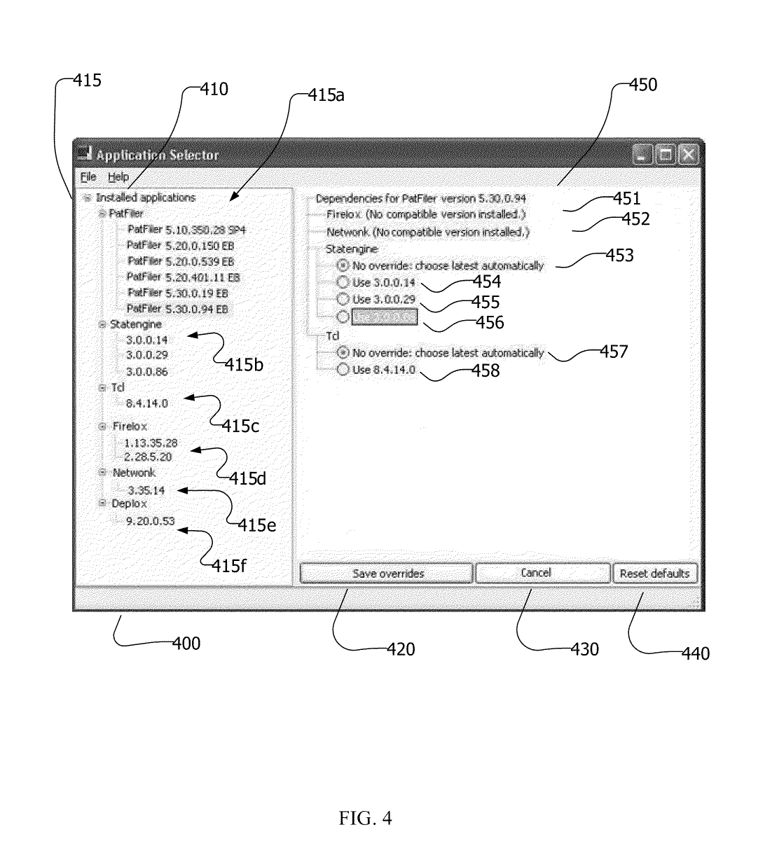

Although program packages can simply run in accordance with their respective dependency lists, using a manager program such as the manager program 170 (FIG. 1) the dependencies may be viewed and changed. These changes may be stored in the dependency list itself or in another location such as the overrides file 175 (FIG. 1). To provide this capability, the manager program may include a graphical tool through which users may view and manage dependencies. Referring now to FIG. 4 there is shown a screen shot of a main display 400 of a manager program such as the manager program 170. The screen shot includes sample data for discussion purposes. The sample data in FIG. 4 is consistent with the example of FIG. 3.

Following common user interface design principles, the main display 400 includes a left pane 410 and a right pane 450. The left pane 410 has a list 415 of names of installed program packages, and the right pane 450 has details about whichever named program package is highlighted in the list 415. Although certain user interface elements and techniques are shown and used, other user interface elements and techniques could be used in place of and in addition to those shown.

The list 415 may include the names of all or a subset of the installed program packages. The list 415 may include only those program packages with dependencies, locally installed, available to be run, and/or having manageable dependencies. The list 415 may include some but not all installed versions of a given program package.

In the example of FIG. 4, the list 415 has names of six primary program packages. These six program packages are named PatFiler, Statengine, Tcl, Firelox, Netwonk and Deplox and there is a sublist of versions for each, referenced in the drawing as 415a, 415b, 415c, 415d, 415e. 415f. PatFiler has a sublist 415a with six versions. Statengine has a sublist 415b with three versions. Tcl has a sublist 415c with one version. Firelox has a sublist 415d with two versions. Netwonk has a sublist 415e of one version. Deplox has a sublist 415f with one version. Note that the versions in the PatFiler sublist 415a are within the version ranges 310, 350 in the dependency list 300 in FIG. 3. However, it is possible that versions of a primary program package might be within ranges in a dependency list but not in the corresponding sublist, and vice-versa.

In the example of FIG. 4, version 5.30.94 EB of PatFiler is highlighted (i.e., selected). Thus, the right pane 450 shows details for this selected version. The right pane 450 shows the names of four secondary program packages upon which PatFiler version 5.30.94 depends, namely Firelox, Netwonk, Statengine and Tcl. For each of these secondary program packages, the manager program may identify which installed versions of the secondary program package are compatible with the selected primary program package. The manager program may determine which versions are installed from operating system services, such as the Windows Registry, or from the dependency list of the primary program package.

For both Firelox and Netwonk, the right pane 450 indicates that no multi-version compatible version is installed, referenced as items 451, 452. In such a case, even if multiple versions of Firelox and Netwonk are available, the version selection is made automatically and without user input. This may arise where installation of later versions of a secondary program package, such as both Firelox and Netwonk in this example, create conflicts with earlier versions. In such a case, the manager program may prevent the user from selecting specific versions of the secondary program package to be used with the selected primary program package. In the current example, there are two versions of Firelox installed and shown in the sublist 415d and one version of Netwonk installed shown in the sublist 415e. Thus, the manager program ensures that user cannot select which of the two Firelox versions should be used with PatFiler version 5.30.94 EB.

For Statengine, the right pane 450 shows radio button options 453, 454, 455, 456. The first option 453 is no override, which is normally a default. The default may be to use the highest compatible version of the installed versions of the secondary program package. The user may override this default 453 by selecting one of the specific versions listed 454, 455, 456. For Tcl, a similar arrangement applies in the example, with a default 457 and one override option 458.

The main display 400 may also include buttons for saving the overrides 420 for the selected primary program package, canceling the changes 430 of the settings for the selected primary package, and resetting to defaults 440 for the selected primary program package. Overrides may be saved to the overrides file 175 described above.

Thus, using the manager program's user interface, a user can choose to override the default depended-upon version of one or more secondary program packages. This allows a user to modify the settings for a primary program package to force it to load a particular version of a secondary program package. The system may also provide users the option to use or block beta releases of secondary software programs either for all secondary software programs or for specified secondary software programs.

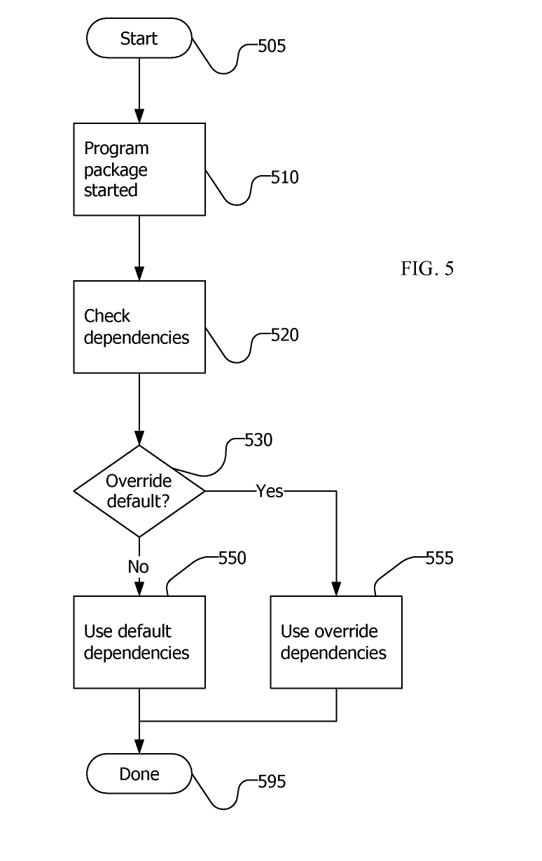

The discussion so far has covered how dependencies are defined and changed. Next is a discussion of how the overrides file is used by primary program packages. Referring now to FIG. 5 there is shown a flow chart of a process for running a primary program package. The flow chart has both a start 505 and an end 595, but the process is recursive in nature.

In step 510, the primary program package is started. The primary program package may be selected and/or started manually or automatically.

After the primary program package starts 510, a check is made for the primary program package's dependencies 520. In this step 520, the secondary program packages are identified, as are the respective versions to be used by default. This may be by reference to the dependency list for the primary program package and/or the Windows Registry, for example.

Next, it may be determined if any of the defaults should be overridden 530, for example by referencing an overrides file. If there is an override then the override dependency is used 555. If there are no overrides for the primary program package then the defaults are used, and if there is no override for a specific secondary program package then the default for that secondary program package is used 550.

Steps 520 and 530 may be performed by the primary program package, by the manager program, or through another service. At runtime or at a later time such as when a secondary program package is needed, the primary program package may query the program manager, which will examine the installed program packages and return the appropriate version for each program package that the primary program packaged depends upon. The manager program may return either the highest version of the secondary program package or the version based on the overridden dependency in the overrides file. The overridden dependency takes precedence.

Using the technology described above, users can reliably switch back and forth between multiple versions of a given program package. Motivations for these changes might include periods after releases when bugs can temporarily force users to use older more stable builds, and newer builds might not work with the versions of program products which users are using. In this vein, a user may learn whether a beta version of a secondary program is sufficiently stable to use with a particular primary program. For some program packages, it may be possible to run multiple instances even if the instances are different versions, but for other program packages it may be desirable to prevent this. There may also be licensing restrictions on installing multiple versions of a program product.

Closing Comments

The computer system 100 of FIG. 1 may include software and/or hardware for providing functionality and features described herein. A computer system may therefore include one or more of: logic arrays, memories, analog circuits, digital circuits, software, firmware, and processors such as microprocessors, field programmable gate arrays (FPGAs), application specific integrated circuits (ASICs), programmable logic devices (PLDs) and programmable logic arrays (PLAs). The hardware and firmware components of the computer system 100 may include various specialized units, circuits, software and interfaces for providing the functionality and features described here. The processes, functionality and features may be embodied in whole or in part in software which operates on the computer system and may be in the form of firmware, an application program, an applet (e.g., a Java applet), a browser plug-in, a COM object, a dynamic linked library (DLL), a script, one or more subroutines, or an operating system component or service. The hardware and software and their functions may be distributed amongst several devices.

The computer system 100 may be a personal computer, server computer, computing tablet, set top box, video game system, personal video recorder, telephone, personal digital assistant (PDA), portable computer, and laptop computer. The computer system 100 may run an operating system, including, for example, variations of the Linux, Microsoft Windows, Symbian, and Apple Mac operating systems.

The storage medium 140 may be or include one or more of magnetic media such as hard disks, floppy disks and tape; optical media such as compact disks (CD-ROM and CD-RW) and digital versatile disks (DVD and DVD±RW); solid state memory such as solid-state drives (SSDs), DRAM and flash; and other storage media.

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

For means-plus-function limitations recited in the claims, the means are not intended to be limited to the means disclosed herein for performing the recited function, but are intended to cover in scope any means, known now or later developed, for performing the recited function.

As used herein, “plurality” means two or more.

As used herein, a “set” of items may include one or more of such items.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

As used herein, “and/or” means that the listed items are alternatives, but the alternatives also include any combination of the listed items.

It is claimed:

1. Apparatus comprising a storage medium storing a manager program having instructions which when executed by a processor will cause the processor to manage dependencies of a plurality of program packages, wherein the program packages have respective version numbers, and plural versions of at least one of the program packages are available to be run on the processor, the instructions of the manager program for:
for a first one of the program packages
identifying as second program packages those program packages that are depended upon by the first program package
identifying versions of the second program packages that are compatible with the first program package
providing to a user an option to select a specific one of the identified versions of at least one of the second program packages
receiving a user input indicative of which of the identified versions the second program packages to use as selected versions
causing the first program package to depend on the selected versions of the second program packages.

2. The apparatus of claim 1, the instructions of the manager program further for performing the identifying steps, the providing step and the causing step with respect to additional program packages.

3. The apparatus of claim 1, the instructions of the manager program further for performing the identifying steps, the providing step and the causing step with respect to multiple versions of the first program package.

4. The apparatus of claim 1, wherein the providing comprises
displaying a name of the first program package
displaying a name of at least one of the second program packages
displaying the version numbers of the identified versions of the second program packages, in association with the name of the second program packages.

5. The apparatus of claim 4 wherein the providing further comprises displaying a default option in addition to the identified versions of the second program packages, wherein when a user input indicative of the default option is received, setting as the selected version a highest of the version numbers of the identified versions.

6. The apparatus of claim 1, the storage medium further storing a dependency list for the first program package, the dependency list comprising
a list of at least one of the program packages upon which the first program package is dependent
for at least one of the listed program packages, a sub-list of version numbers of versions with which the first program package is compatible.

7. The apparatus of claim 6, wherein the sub-list comprises at least one range.

8. The apparatus of claim 1, wherein
the storage medium stores for the first program package, either
a default setting for the first program package, the default setting corresponding to a highest of the version numbers of the identified versions
an override of the default setting corresponding to the selected versions
the causing comprises obtaining from the storage medium the default setting or the override of the default setting.

9. The apparatus of claim 1, the manager program further for
identifying a third program package upon which the first program package is dependent, wherein even if multiple versions of the third program package are available, the version selection is made without user input.

10. The apparatus of claim 1 further comprising the processor.

11. The apparatus of claim 1 consisting of the storage medium.

12. The apparatus of claim 1 wherein the program packages are installed on the storage medium.

13. A process for managing dependencies of program packages available to be run on a processor, wherein the program packages have respective version numbers, and plural versions of at least one of the program packages are available to be run on the processor, the process comprising:
for a first one of the program packages
identifying as second program packages those program packages that are depended upon by the selected program package
identifying versions of the second program package that are compatible with the first program package
providing to a user an option to select a specific one of the identified versions of at least one of the second program packages
receiving a user input indicative of which of the identified versions of the second program packages to use as a selected versions
causing the first program package to depend on the selected version of the second program package.

14. The process of claim 13 further comprising performing both of the identifying, the providing and the causing with respect to additional program packages.

15. The process of claim 13 further comprising performing both of the identifying, the providing and the causing with respect to multiple versions of the first program package.

16. The process of claim 13, wherein the providing comprises
displaying a name of the first program package
displaying a name of at least one of the second program packages
displaying the version numbers of the identified versions of the second program package, in association with the name of the second program packages.

17. The process of claim 16 wherein the providing further comprises displaying a default option in addition to the identified versions of the second program packages, wherein when a user input indicative of the default option is received, setting as the selected version a highest of the version numbers of the identified versions.

18. The process of claim 13 wherein
the causing comprises obtaining either
a default setting for the first program package, the default setting corresponding to a highest of the version numbers of the identified versions, or
an override of the default setting corresponding to the selected versions.

19. The process of claim 13 further comprising
identifying a third program package upon which the first program package is dependent, wherein even if multiple versions of the third program package are available, the version selection is made without user input.
